(19) United States
(12) Patent Application Publication
(10) Pub. No.: US 2015/0145186 A1
(43) Pub. Date: May 28, 2015

(54) Higher Strength, Mullite-Based Iron Foundry Filter

(71) Applicant: Porvair PLC, Norfolk (GB)

(72) Inventor: Rudolph A. Olson, III, Hendersonville, NC (US)

(73) Assignee: PORVAIR PLC a corporation

(21) Appl. No.: 14/401,767

(22) PCT Filed: Jul. 25, 2013
(86) PCT No.: PCT/US2013/052051

§ 371 Date: Nov. 17, 2014

Related U.S. Application Data
(60) Provisional application No. 61/676,500, filed on Jul. 27, 2012.

(51) Int. Cl. B01D 39/20; C04B 35/58; C04B 38/06; C22B 9/02; B01D 71/02

(52) U.S. Cl. CPC B01D 39/2068; C22B 9/023; B01D 71/02; C04B 38/06; C04B 35/58085
USPC 266/227; 264/44

(57) ABSTRACT

A ceramic foam filter and method of making the filter is described. The filter comprises: a sintered reaction product of: 35-75 wt % aluminosilicate; 10-30 wt % colloidal silica; 0-2 wt % bentonite; and 0-35 wt % fused silica; wherein the ceramic foam filter has less than 0.15 wt % alkali metals measured as the oxide and a flexural strength of at least 60 psi measured at 4 minutes at 1428° C.

### CROSS-REFERENCE TO RELATED APPLICATIONS

This application claims priority to pending U.S. Provisional Patent Appl. No. 61/676,500 filed Jul. 27, 2012 which is incorporated herein by reference.

### BACKGROUND

The present invention is related to improved filters for molten iron and the method of making improved filters for molten iron. More specifically, the present invention is related to improved filters comprising lower alkali content which mitigates the problems caused by the formation of a previously unrealized transient liquid phase that occurs during iron filtration. Much of this liquid phase then ultimately transforms to a previously unrealized solid cristobalite phase during iron filtration.

The filtration of molten iron has been practiced for some time and is well known. Iron filtration has historically been done by passing molten iron through strainers whereby some level of filtration was achieved. More advanced filtration has been done using porous foam mullite based filters, as described in U.S. Pat. No. 7,718,114 which is incorporated herein by reference, wherein the tortuous path increases the filtration efficiency.

A perplexing problem with porous foam mullite based filters has been the filter rupture, or creep, whereby the filter would either break or deform when subjected to very difficult filtration conditions. Molten iron is at a temperature in excess of 1400° C. and the pours are typically large volumes. Those of skill in the art long considered the failure to be a mechanical failure due to the rapid change in temperature, coupled with the excessive pressure associated with a large volume of molten iron above the filter. Efforts to improve the robustness were focused on increasing the hot modulus of rupture (MOR), which was considered to be representative of the dynamics during the pour. Alternatively, efforts were focused on eliminating creep, which is defined as a plastic deformation near the melting point of the material and tends to be a function of time, temperature and load placed on the material.

Through diligent research, the instant inventors have identified previously unrealized transient liquid and subsequent solid cristobalite phases which form during the initial stages of the pour. These transient liquid phases are believed to be a primary reason for failure in a filter. The identity of this previously unrealized failure mode has led to the development of a mullite based filter which is stronger and much less susceptible to failure during molten metal filtration.

### SUMMARY OF THE INVENTION

It is an object of the invention to provide an improved mullite based porous filter.

It is another object of the invention to provide a mullite based porous filter which is more robust, thereby being less likely to fail than prior mullite based filters.

It is another object of the invention to enable the creation of a lower density filter with equivalent strength to the standard product, thereby achieving a higher flow rate due to the more open structure without sacrificing strength.

These and other advantages, as will be realized, are provided in a ceramic foam filter comprising a sintered reaction product of:

35-75 wt % aluminosilicate;

10-30 wt % colloidal silica;

0-2 wt % bentonite;

0-35 wt % fused silica; and

0-10 wt % pore formers;

wherein the ceramic foam filter has less than 0.15 wt % alkali metals measured as the oxide.

Yet another embodiment is provided in a ceramic foam filter comprising a sintered reaction product of:

35-75 wt % aluminosilicate;

10-30 wt % colloidal silica;

0-2 wt % bentonite;

0-35 wt % fused silica; and

0-10 wt % pore formers;

wherein the ceramic foam filter of size 75×100×13-mm has a flexural strength of at least 60 psi when inserted directly into a kiln at 1428° C. and measured at 4 minutes residence time.

Yet another embodiment is provided in a ceramic foam filter comprising a sintered reaction product of:

35-75 wt % aluminosilicate;

10-30 wt % colloidal silica;

0-2 wt % bentonite; and

0-35 wt % fused silica;

wherein the ceramic foam filter of size 75×100×13-mm has less than 0.15 wt % alkali metals measured as the oxide and a flexural strength of at least 60 psi when inserted directly into a kiln at 1428° C. and measured at 4 minutes residence time.

Yet another embodiment is provided in a process for forming a ceramic foam filter comprising the steps of: preparing a ceramic precursor comprising:

35-75 wt % aluminosilicate;

10-30 wt % colloidal silica;

0-2 wt % bentonite;

0-35 wt % fused silica;

0-10 wt % pore formers; and

solvent in balance;

impregnating an organic foam with the ceramic precursor;

heating the impregnated organic foam to a temperature sufficient to volatize the organic foam and sinter the ceramic precursor thereby forming the ceramic foam filter;

wherein the ceramic foam filter has less than 0.15 wt % alkali metals measured as the oxide.

Yet another embodiment is provided in a process for forming a ceramic foam filter comprising the steps of:

preparing a ceramic precursor comprising:

35-75 wt % aluminosilicate;

10-30 wt % colloidal silica;

0-2 wt % bentoniate;

0-35 wt % fused silica;

0-10 wt % pore formers; and

solvent in balance;

impregnating an organic foam with the ceramic precursor;

heating the impregnated organic foam to a temperature sufficient to volatize the organic foam and sinter the ceramic precursor thereby forming the ceramic foam filter;

wherein the ceramic foam filter of size 75×100×13-mm has a flexural strength of at least 60 psi when inserted directly into a kiln at 1428° C. and measured at 4 minutes residence time.

### DESCRIPTION

The instant invention is specific to a mullite based porous foam filter which is less susceptible to failure during molten metal filtration. More specifically, the present invention is specific to a mullite based porous foam filter with a chemical composition which does not as readily form transient liquid phase during the heating cycle from ambient temperature to the temperature of molten iron. By minimizing the presence of sodium in the filter body, the transient liquid is minimized, thereby eliminating a previously unrealized failure mode of the mullite based porous ceramic filter.

While not limited to any theory, it has now been realized that a transient liquid phase forms during pouring of the molten metal. The liquid eventually crystallizes into solid cristobalite during the pour. The amount of transient liquid phase is variable depending on the rate of heating, ceramic composition, and other variables which are difficult to measure or control. Prior testing of filter robustness, or strength, was either done at ambient temperature or at temperature of use. Therefore, those of skill in the art had no ability to realize the presence of a transient liquid phase and therefore had neither the motivation nor the ability to minimize the presence thereof. Minor levels of cristobalite have been observed in filters, yet this is a common impurity in mullite and was therefore ignored. By realizing the near instantaneous formation of a transient liquid phase, which eventually crystallizes to cristobalite, the inventors have been able to modify mullite based filters to minimize the liquid phase formation and improve the thermomechanical properties of the filter as it progresses through this transient stage to cristobalite crystallization.

Ceramic foam filters are made by foam replication technique, which is a common method used to manufacture reticulated ceramic foam for use as molten metal filtration devices. An organic foam, typically polyurethane, is coated with a ceramic slurry and then dried and fired. During firing the organic foam vaporizes leaving the ceramic foam structure as an exoskeleton-like ceramic foam having hollow voids where the polyurethane once resided. The structure is a connection of struts with porosity around and within the struts. The process of forming ceramic foam is provided in U.S. Pat. Nos. 4,056,833 and 5,673,902, each of which is incorporated herein by reference.

The slurry depends on the desired ceramic material for the chosen application. The slurry must have sufficient properties such that the final product can withstand chemical attack and must provide a ceramic with sufficient structural and/or mechanical strength to stand up to the elevated temperatures which occur during a pour. In addition, the slurry should have a relatively high degree of fluidity and may comprise an aqueous suspension of the ceramic intended for use in the filter. Normally, the slurry contains water. Additives, such as binders and surfactants, may be employed in the slurry.

The flexible foam material is impregnated with the ceramic slurry so that the fiber-like webs are coated therewith and the voids are filled therewith. Normally, it is preferred to repeatedly immerse the foam in the slurry and compress the foam between immersions to insure complete impregnation of the foam.

The impregnated foam is preferably compressed to expel from 25 to 75% of the slurry while leaving the fiber-like web portion in the foam coated with slurry. In a continuous operation, one may pass the impregnated foam through a preset roller to affect the desired expulsion of slurry from the foam and leave the desired amount impregnated therein. This may be done manually by simply squeezing the flexible foam material to the desired extent. At this stage, the foam is still flexible and may be formed into configurations suitable for the specific filtration task, i.e., into curved plates, hollow cylinders, etc. It is necessary to hold the formed foam in position by conventional means until the polymeric substrate is decomposed, or preferably until the ceramic is sintered. The impregnated foam is then dried by either air drying or accelerated drying at a temperature of from 35 to 700° C. for from 2 minutes to 6 hours. After drying, the material is heated at an elevated temperature to bond the ceramic particles making up the fiber-like webs. It is preferred to heat the dried impregnated material in two stages, with the first stage being to heat to a temperature of from 350 to 700° C. and holding within this temperature range for from 2 minutes to 6 hours in order to burn off or volatilize the web of flexible foam. Clearly this step can be part of the drying cycle, if desired. The second stage is to heat to a temperature of from 900 to 1700° C. and to hold within that temperature range for from 2 minutes to 10 hours in order to bond the ceramic. The resulting product is a fused ceramic foam having an open cell structure characterized by a plurality of interconnected voids surrounded by a web of the ceramic. The ceramic foam may have any desired configuration based on the configuration needed for the particular molten metal filtration process.

The process for forming the inventive filter comprises forming a slurry of ceramic precursors. For the purposes of the present invention, ceramic precursors include specific ratios of refractory aluminosilicate, colloidal silica, fumed or fused silica and modified bentonite. The slurry may comprise a surfactant to decrease the surface tension of the aqueous phase to below 80 mN/m for improved wetting characteristics.

The term “refractory aluminosilicate” as used herein refers to refractory raw materials that comprise predominantly mullite and which possess a pyrometric cone equivalent (PCE) of at least 20. This class of raw materials is also known in the refractory materials literature by the synonyms calcined fireclay, calcined aggregate, refractory calcines, mullite calcines, refractory aggregates, calcined kyanite, electrofused mullite and chamottes.

The ceramic precursor of the present invention comprises about 35-75 wt % refractory aluminosilicate, about 10-30 wt % colloidal silica, about 0 to 2 wt % bentonite or modified bentonite which has a polymeric rheology modifier added, about 0 to 35 wt % fumed or fused silica and about 0-10 wt % pore former with the balance being a solvent, preferably water, present in a sufficient amount to allow the composition to flow into the foam. The ceramic precursor comprise no more than 0.15 wt % alkali metals reported as the oxide. More preferably, the ceramic precursor comprises less than 0.12 wt % sodium reported as Na₂O. Even more preferably, the ceramic precursor comprises less than 0.10 wt % sodium reported as Na₂O. It is preferable that the sodium content be as low as practical with the realization that removing all of the sodium is difficult. About 5-8 wt % water is particularly preferred as the solvent. More preferably, the ceramic composition comprises 40-75 wt % and most preferably 50-70 wt % refractory aluminosilicate. Below about 40 wt % refractory aluminosilicate, the FeO may not adequately wet the interior surfaces of the filter to allow wicking into the interstices where it is retained. Filters made with less than 50 wt ° A. refractory aluminosilicate may also be more sensitive to thermal shock in application. Above about 60 wt % refractory aluminosilicate the filter strength is compromised. More preferably the ceramic precursor comprises 10-23 wt % colloidal silica. More preferably the ceramic precursor comprises about 0.6 to 1.5 wt % bentonite or modified bentonite and most preferably about 0.8 wt % bentonite or modified bentonite. More preferably, the ceramic precursor comprises about 5-20 wt % fumed silica. Fumed and fused silica can be used interchangeably in the present invention in any ratio up to the total amount of fumed or fused silica as set forth herein.

Colloidal Silica is available as pH stabilized silica and pH stabilized silica is the preferred component. For the purposes of the present invention ammonium stabilized silica is a particularly preferred precursor component since this minimizes the amount of sodium added to the slurry.

The density of the resulting filter is preferably at least 8 wt % of theoretical density to no more than 18 wt % of theoretical density. Above 18 wt % of theoretical density, the filtering rate is too slow to be effective. Below 8 wt % of theoretical density, the strength of the filter is insufficient for use in filtering molten iron. The density target for prior art mullite-based filters was developed experimentally to be about 0.422 g/cc or 15.4% of the theoretical density of the ceramics, which are 2.7 g/cc. Traditional filters required a higher density to insure that adequate material was present in the struts to overcome the formation of the previously unrealized transient liquid phase and the resulting cristobalite phase formed thereby. With the minimization of this previously unrealized failure mode, the filters can be made at a lower density while still having sufficient strength.

Most refractory aluminosilicate materials are naturally occurring. For example, mullite has a nominal composition of 3Al₂O₃.2SiO₂. In practice, refractory aluminosilicate typically comprises from about 45 wt % to 80 wt % Al₂O₃ and about 20 wt % to about 50 wt % SiO₂. Naturally occurring impurities are present, and one of skill in the art would realize that completely removing the impurities is cost prohibitive. In practice, refractory mullite has about 1.5-3 wt % TiO₂, up to about 1.5 wt % Fe₂O₃, up to about 0.06 wt % CaO, up to about 0.8 wt % MgO, up to about 0.07 to 0.09 wt % Na₂O, up to about 0.04 to 0.09 wt % K₂O and up to about 0.12 wt % P₂O₅. For the purposes of the present invention, it is preferred that refractory aluminosilicates which are modified to have a lower level of alkali metals, and particularly lower sodium, are preferred.

In an alternative embodiment, a ceramic precursor comprising spherically shaped voids therein can be formed into the desired shape of the porous ceramic and fired as described in U.S. Pat. No. 6,773,825, which is incorporated herein by reference thereto.

A mixture of ceramic or metal particles and pliable organic spheres as the pore former is prepared into a liquid, or suspension, and the mixture is formed into a shaped article. The shaped article is dried and fired so that the particles are bonded by sintering. The organic spheres and other organic additives are volatilized. The spheres are preferably low density and more preferably hollow. The size of the voids may be preselected by selecting the appropriate polymer spheres. The porosity is also easily controlled by the number of polymer spheres added. It is most preferred that the polymer spheres are each in contact with at least two other spheres such that a network of voids is created in the eventual filter.

To a suspension of ceramic precursor is added pliable organic hollow spheres which are simultaneously suspended in the solvent as a pore former. The ceramic precursor is then incorporated into the foam as described further herein and dried to remove the solvent. When the ceramic precursor is fired to form a ceramic, the spheres are volatilized resulting in uniformly distributed voids throughout the filter lattice. Using this method, a range of porosities can be achieved, however, for use in molten iron filtration it is preferable that the porosity be no more than 60% of the volume of the ceramic due to insufficient strength at higher levels of porosity. The porosity and pore size is easily controlled by the number and sizes of polymer spheres used. After firing, the void is substantially the same shape and size as the included sphere. It is most preferably to utilize spheres with an average diameter of 20 to 150 microns and more preferably 20-80 microns. An 80 micro sphere is most preferred. Other organic pore formers may be utilized, including flour, cellulose, starch and the like. Hollow organic spheres are most preferred due to the low volume of organic-to-pore volume which can be achieved and the minimal level of organic residue remaining after firing. These hollow beads are typically added as a mixture of 90% water and 10% spheres by weight. It is most preferred that the slurry comprise up to about 10 wt % pore former mixture based on an 80 micron hollow sphere.

The material is either formed to size or cut to size. The material can be cut to size as a green ceramic or as a sintered ceramic.

### EXAMPLES

A standard mullite filter (Control) was prepared as in U.S. Pat. No. 7,718,114 using industry standard sodium stabilized colloidal silica having about 30 wt % SiO₂, 0.55 wt % Na₂O, and an average particle size of 8 nm. Representative sodium stabilized colloidal silica is provided by Eka Chemicals as Bindzil 830 or from Nyacol as NexSil 8. The material was fired through a rollerhearth in about 22 minutes with a standard hot zone temperature of about 1250° C. and a standard residence time in the hot zone of about 8 minutes. Inventive examples (Inv.) were identically prepared with the exception of the colloidal silica, which was ammonium stabilized colloidal silica available as (NexSil 20NH4) from Nyacol having less than 0.05 wt % Na₂O. The filters were fired using standard production run rates (Stand) and at a slow run rate (Slow) that was 75% of the standard run rate. The firing temperatures were done at standard 1250° C. (Stand) or at a higher temperature of 1280° C. (High). The strength of each mullite filter was tested at 1428° C., representing molten iron temperatures, as a function of time using three-point flexure. The filters were inserted directly into the kiln set at 1428° C., and the time indicates the residence time the filter was exposed to before it was broken. As indicated in Table 1, the density did not vary appreciably. The Flexural Strength (psi) is reported in Table 2.

TABLE 1

| | | | 18 Sec. | 1 Min. | 4 Min. |
|---|---|---|---|---|---|
| Slurry | Speed | Temp | Density | Density | Density |
| Control | Stand | Stand | 16.0 | 16.1 | 16.2 |
| Control | Slow | Stand | 16.6 | 16.4 | 16.6 |
| Control | Stand | High | 16.2 | 16.3 | 16.3 |
| Inv. | Stand | Stand | 16.3 | 16.5 | 16.4 |
| Inv. | Slow | Stand | 16.7 | 16.5 | 16.3 |
| Inv. | Stand | High | 16.9 | 16.6 | 16.9 |

TABLE 2

| | | | 18 Sec. | 1 Min. | 4 Min. |
|---|---|---|---|---|---|
| | | | Flexural | Flexural | Flexural |
| Slurry | Speed | Temp | Str. | Str. | Str. |
| Control | Stand | Stand | 111.0 | 51.2 | 57.0 |
| Control | Slow | Stand | 113.7 | 56.0 | 55.6 |
| Control | Stand | High | 94.9 | 62.4 | 53.8 |
| Inv. | Stand | Stand | 115.9 | 53.1 | 77.5 |
| Inv. | Slow | Stand | 101.7 | 66.6 | 75.4 |
| Inv. | Stand | High | 124.6 | 85.9 | 83.5 |

The results illustrate a significant improvement in the strength of the filter as a function of time. Though the instantaneous effects during an actual pour of molten metal are not easily measured, the instant results model the reactivity in a suitable fashion to illustrate that the flexural strength relative to the 18 second measurement does not decrease as much with the inventive samples as with the control samples. Under each condition, the inventive sample maintains a higher level of flexural strength and exhibits a flexural strength of at least 60 psi, and more preferably at least 70 psi, when measured at 4 minutes at a temperature of 1428° C. This level of flexural strength is not achievable at reasonable density levels with the control samples.

While not limited by theory, it is believed that by going to higher temperature, more of the liquid phase is transformed to cristobalite before the filter sees service in molten metal. The result is an improved performance when reducing sodium. Similar results are observed when increasing firing temperature.

The soda contents, reported as wt % Na₂O, of standard and inventive mullite filter samples were measured using a Panalytical Model 2400PW X-Ray Fluorescence (XRF) Spectrometer. Pellets were created by co-grinding 9.00 grams of ceramic with 1.00 gram of Copolywax E4 powder, available from Cargille Tab-Pro Corporation, for two minutes in a Spectromill ball pestle impact grinder (available from Chemplex Industries). A cylindrical die with an inner diameter of 28.5-mm was charged with 6.66 grams of the co-ground material. The powder was then pressed to loads of 600, 1200, and 1800-lbs in sequence, and with holding for 30 seconds at each interval. The resultant pressed pellet was then ejected and care was taken to avoid contamination before XRF analysis. Table 3 shows soda content values for standard mullite product obtained from four different production runs, and Table 4 shows the results obtained from five different runs of the inventive product. The standard product had an average soda content of over 0.17 wt %, more than double that of the inventive product, which had an average soda content of no more than 0.15 wt %.

TABLE 3

| Sample | Wt % |
|---|---|
| Number | Na₂O |
| C-1 | 0.19 |
| C-2 | 0.20 |
| C-3 | 0.18 |
| C-4 | 0.19 |
| Average | 0.19 |

TABLE 4

| Sample | Wt % |
|---|---|
| Number | Na₂O |
| I-1 | 0.09 |
| I-2 | 0.08 |
| I-3 | 0.10 |
| I-4 | 0.08 |
| I-5 | 0.10 |
| Average | 0.09 |

These measurements were verified by measuring a certified reference material obtained from Instituto de Pesquisas Tecnologicas (IPT 51 No. 1923-103) prepared in identical fashion. This reference material was chosen because it had alumina and silica contents similar to the mullite product, as shown in Table 5, and soda content similar to values we were measuring, as shown in Table 6. The expanded uncertainty of the certified value was estimated by the combination, according to ISO Guide 35:2006, of uncertainties of characterization obtained experimentally from the interlaboratory certification program data, and where relevant, with contributions of stability of material, both estimated at IPT. The coverage factor used is approximately 2, providing a confidence level of 95%.

TABLE 5

| | Wt % | Wt % |
|---|---|---|
| | Alumina | Silica |
| Mullite | 44 | 53 |
| IPT Standard | 40 | 55 |

TABLE 6

| | Wt % | Expanded |
|---|---|---|
| | Na₂O | Uncertainty |
| IPT Standard | 0.09 | 0.02 |

Eighty grams of reference material were obtained and four pellets were created using the identical procedure described above. One measurement was made per pellet, and the results are displayed in Table 7. The average value for the four measurements is within the uncertainty range of plus or minus 0.02 wt % specified by the standard with 95% confidence.

TABLE 7

| | Wt % |
|---|---|
| Sample | Na₂O |
| 1 | 0.12 |
| 2 | 0.11 |
| 3 | 0.11 |
| 4 | 0.11 |
| Average | 0.11 |

The invention has been described with reference to the preferred embodiments without limit thereto. One of skill in the art would realize additional embodiments and improvements which are not specifically set forth herein, but which are within the scope of the invention as more specifically set forth in the claims appended hereto.

1. A ceramic foam filter comprising:
a sintered reaction product of:
35-75 wt % aluminosilicate;
10-30 wt % colloidal silica;
0-2 wt % bentonite;
0-35 wt % fused silica; and
0-10 wt % pore formers;
wherein said ceramic foam filter has less than 0.15 wt % alkali metals measured as the oxide.

2. The ceramic foam filter of claim 1 comprising less than 0.12 wt % alkali metals measured as the oxide.

3. The ceramic foam filter of claim 1 alkali metals includes sodium.

4. The ceramic foam filter of claim 3 comprising less than 0.15 wt % sodium measured as Na₂O.

5. The ceramic foam filter of claim 1 having a flexural strength of at least 60 psi measured at 4 minutes at 1428° C.

6. The ceramic foam filter of claim 1 having a flexural strength of at least 70 psi measured at 4 minutes at 1428° C.

7. The ceramic foam filter of claim 1 comprising 40-75 wt % aluminosilicate.

8. The ceramic foam filter of claim 7 comprising 50-70 wt % aluminosilicate.

9. The ceramic foam filter of claim 1 comprising 10-30 wt % colloidal silica.

10. The ceramic foam filter of claim 9 comprising 10-20 wt % colloidal silica.

11. The ceramic foam filter of claim 1 comprising 0.6-1.5 wt % bentonite.

12-21. (canceled)

22. A ceramic foam filter comprising:
a sintered reaction product of:
35-75 wt % aluminosilicate;
10-30 wt % colloidal silica;
0-2 wt % bentonite; and
0-35 wt % fused silica;
wherein said ceramic foam filter has less than 0.15 wt % alkali metals measured as the oxide and a flexural strength of at least 60 psi measured at 4 minutes at 1428° C.

23-31. (canceled)

32. A process for forming a ceramic foam filter comprising the steps of:
preparing a ceramic precursor comprising:
35-75 wt % aluminosilicate;
10-30 wt % colloidal silica;
0-2 wt % bentonite;
0-35 wt % fused silica;
0-10 wt % pore formers; and
solvent in balance;
impregnating an organic foam with said ceramic precursor;
heating said impregnated organic foam to a temperature sufficient to volatize said organic foam and sinter said ceramic precursor thereby forming said ceramic foam filter;
wherein said ceramic foam filter has less than 0.15 wt % alkali metals measured as the oxide.

33. The process for forming a ceramic foam filter of claim 32 comprising less than 0.12 wt % alkali metals measured as the oxide.

34. The process for forming a ceramic foam filter of claim 32 alkali metals include sodium.

35. The process for forming a ceramic foam filter of claim 34 comprising less than 0.15 wt % sodium measured as Na₂O.

36. The process for forming a ceramic foam filter of claim 35 comprising less than 0.10 wt % sodium measured as Na₂O.

37. The process for forming a ceramic foam filter of claim 32 having a flexural strength of at least 60 psi measured at 4 minutes at 1428° C.

38. The process for forming a ceramic foam filter of claim 32 having a flexural strength of at least 70 psi measured at 4 minutes at 1428° C.

39. The process for forming a ceramic foam filter of claim 32 comprising 40-75 wt % aluminosilicate.

40. The process for forming a ceramic foam filter of claim 32 comprising 50-70 wt % aluminosilicate.

41. The process for forming a ceramic foam filter of claim 32 comprising 10-30 wt % colloidal silica.

42. The process for forming a ceramic foam filter of claim 41 comprising 10-20 wt % colloidal silica.

43. The process for forming a ceramic foam filter of claim 32 comprising 0.6-1.5 wt % bentonite.

44. A process for forming a ceramic foam filter comprising the steps of:
preparing a ceramic precursor comprising:
35-75 wt % aluminosilicate;
10-30 wt % colloidal silica;
0-2 wt % bentoniate;
0-35 wt % fused silica;
0-10 wt % pore formers; and
solvent in balance;
impregnating an organic foam with said ceramic precursor;
heating said impregnated organic foam to a temperature sufficient to volatize said organic foam and sinter said ceramic precursor thereby forming said ceramic foam filter;
wherein said ceramic foam filter has a flexural strength of at least 60 psi measured at 4 minutes at 1428° C.

45-55. (canceled)
